(19) United States
(12) Patent Application Publication
(10) Pub. No.: US 2025/0172212 A1
(43) Pub. Date: May 29, 2025

(54) SLIT VALVE APPARATUS

(71) Applicants: Samsung Electronics Co., Ltd., Suwon-si (KR); PRESYS. Co., Ltd., Suwon-si (KR)

(72) Inventors: Hyungho Kim, Suwon-si (KR); Baejin Kim, Suwon-si (KR); Dongho Lee, Suwon-si (KR); Kangmin Park, Suwon-si (KR); Jongil Yoon, Suwon-si (KR); Geongu Jang, Suwon-si (KR); Seungmin Ryu, Suwon-si (KR); Joonsung Lee, Suwon-si (KR); Hyunsoo Chun, Suwon-si (KR)

(73) Assignees: Samsung Electronics Co., Ltd., Suwon-si (KR); PRESYS. Co., Ltd., Suwon-si (KR)

(21) Appl. No.: 18/918,351

(22) Filed: Oct. 17, 2024

(30) Foreign Application Priority Data
Nov. 29, 2023 (KR) 10-2023-0169179
Dec. 20, 2023 (KR) 10-2023-0187123

(51) Int. Cl. F16K 3/18; F16K 3/02; F16K 47/02

(52) U.S. Cl. CPC F16K 3/184; F16K 3/0218; F16K 47/02

(57) ABSTRACT

A slit valve apparatus includes a door plate opening and closing an opening of a valve housing, a valve rod connected to the door plate, a guide housing disposed at a lower end of the door plate and disposed so that the valve rod passes therethrough, an L-motion block disposed in an internal space of the guide housing and connected to the valve rod, a cam block connected to the L-motion block and disposed in the internal space of the guide housing, a driving rod connected to a lower end of the valve rod, and a driving unit connected to the driving rod to drive the driving rod, wherein the slit valve apparatus further comprises a connector installed in the door plate and connected to the valve rod, wherein the connector includes a body inserted into and disposed in the door plate and an extension portion extending from a lower end of the body, the extension portion includes a first wedge portion preventing the door plate from rotating, and the valve rod includes a second wedge portion corresponding to the first wedge portion.

### CROSS-REFERENCE TO RELATED APPLICATION(S)

This application claims benefit of priority under 35 U.S.C. § 119 to Korean Patent Application Nos. 10-2023-0169179, filed on Nov. 29, 2023, and 10-2023-0187123, filed on Dec. 20, 2023, in the Korean Intellectual Property Office, the disclosures of both of which are incorporated herein by reference in their entireties.

### BACKGROUND

The present inventive concept relates to a slit valve apparatus.

Generally, slit valve apparatuses have been used to open or close a wafer movement passage between a process chamber and a transfer chamber or between a transfer chamber and a loadlock chamber.

However, in the related art slit valve apparatus, when a door plate contacts a housing, either the top or bottom of the door plate contacts first, and as the door plate rotates, a sealing member mounted on the door plate may be twisted or released.

In addition, when the door plate contacts the housing, a shock may occur by a driving unit and noise and vibrations may occur.

### SUMMARY

An aspect of the present inventive concept is to provide a slit valve apparatus capable of preventing a door plate from rotating.

Another aspect of the present inventive concept is to provide a slit valve apparatus capable of alleviating shocks occurring during an operation and reducing noise and vibrations.

According to an aspect of the present inventive concept, a slit valve apparatus includes: a door plate configured to open and close an opening of a valve housing; a valve rod connected to the door plate; a guide housing disposed at a lower end of the door plate and disposed so that the valve rod passes therethrough; an L-motion block disposed in an internal space of the guide housing and connected to the valve rod; a cam block connected to the L-motion block and disposed in the internal space of the guide housing; a driving rod connected to a lower end of the valve rod; and a driving unit connected to the driving rod to drive the driving rod, wherein the slit valve apparatus further comprises a connector installed in the door plate and connected to the valve rod, wherein the connector includes a body disposed in the door plate and an extension portion extending from a lower end of the body, and wherein the extension portion includes a first wedge portion configured to prevent the door plate from rotating, and the valve rod includes a second wedge portion corresponding to the first wedge portion.

According to an aspect of the present inventive concept, a slit valve apparatus includes: a door plate configured to open and close an opening of a valve housing; a valve rod connected to the door plate; a guide housing disposed at a lower end of the door plate and disposed so that the valve rod passes therethrough; an L-motion block disposed in an internal space of the guide housing and connected to the valve rod; a cam block connected to the L-motion block and disposed in the internal space of the guide housing; a driving rod connected to a lower end of the valve rod; and a driving unit connected to the driving rod to drive the driving rod, wherein the driving unit includes a cylinder having an internal space and a piston driven up and down in the internal space of the cylinder, wherein the cylinder includes an inlet through which air flows, an outlet spaced apart from the inlet, and a piston movement recess disposed between the inlet and the outlet and configured to allow the piston to move therein, and wherein the cylinder includes a first orifice connecting the inlet to the piston movement recess and a second orifice connecting the outlet to the piston movement recess.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view illustrating a slit valve apparatus according to an example embodiment;

FIG. 2 is an exploded perspective view illustrating a slit valve apparatus according to an example embodiment;

FIGS. 3 and 4 are diagrams illustrating a guide housing of a slit valve apparatus according to an example embodiment;

FIGS. 5 and 6 are diagrams illustrating a driving unit of a slit valve apparatus according to an example embodiment;

FIG. 7 is a perspective view illustrating a door plate of a slit valve apparatus according to an example embodiment;

FIG. 8 is an exploded perspective view illustrating a door plate of a slit valve apparatus according to an example embodiment;

FIG. 9 is an diagram illustrating the combination of a door plate and a valve rod of a slit valve apparatus according to an example embodiment; and

FIGS. 10 to 12 are diagrams illustrating an operation of a slit valve apparatus according to an example embodiment.

### DETAILED DESCRIPTION

Hereinafter, example embodiments of the present inventive concept will be described with reference to the accompanying drawings. Like reference characters refer to like elements throughout.

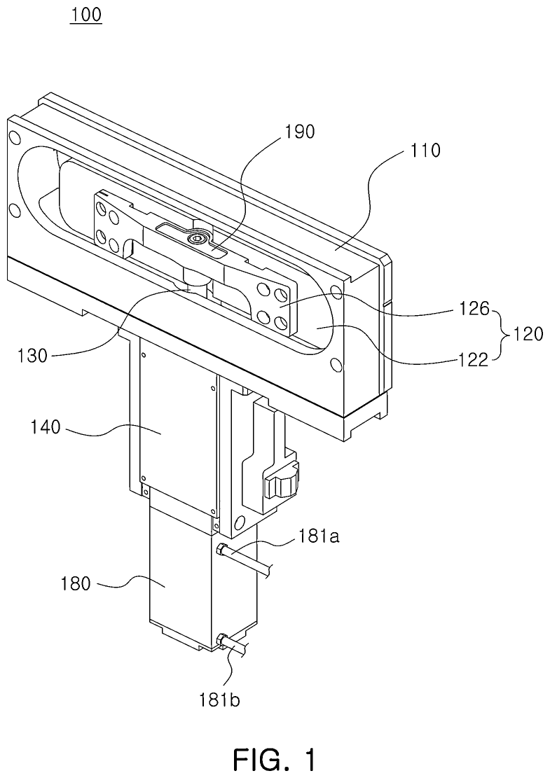

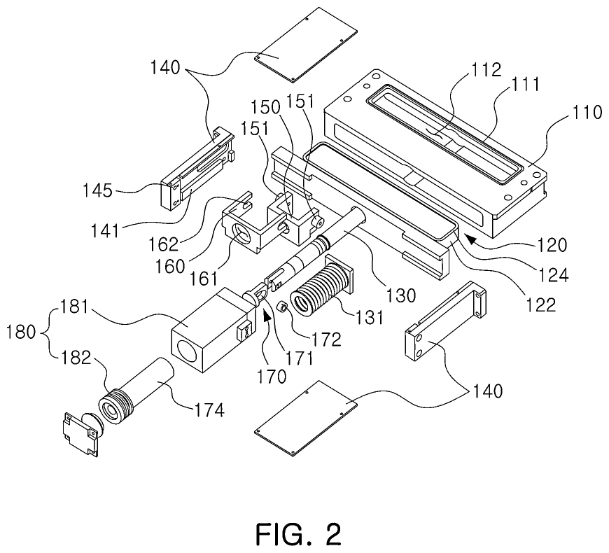

FIG. 1 is a perspective view illustrating a slit valve apparatus according to an example embodiment, and FIG. 2 is an exploded perspective view illustrating a slit valve apparatus according to an example embodiment.

Referring to FIGS. 1 and 2, a slit valve apparatus 100 according to an example embodiment includes a door plate 120, a valve rod 130, a guide housing 140, an L-motion block 150, a cam block 160, a driving rod 170, and a driving unit 180.

The door plate 120 is disposed in an internal space of a valve housing 110 and opens and closes an opening 112 provided in the valve housing 110. As an example, the door plate 120 may be in close contact with a valve seat 111 formed around the opening 112 to close the opening 112 from the inside. For example, the door plate 120 may contact the valve seat 111 formed around the opening 112, thereby sealing the opening 112 from the inside. Meanwhile, the door plate 120 may be raised and lowered and moved horizontally by the driving unit 180 to be described below. A detailed description thereof is given below.

In this manner, the opening 112 of the valve housing 110 is opened or closed by the door plate 120, thereby implementing the opening and closing operations of the slit valve apparatus 110.

The valve rod 130 is connected to the door plate 120 and is disposed to penetrate through the valve housing 110, and a lower end thereof is disposed in a bellows 131. As an example, the lower end of the valve rod 130 may maintain airtightness through the bellows 131 and may be raised and lowered and moved horizontally together with the door plate 120. For example, the lower end of the valve rod 130 may be raised and lowered in a vertical direction and moved horizontally together with the door plate 120 in a first horizontal direction. Meanwhile, the valve rod 130 may be coupled to the door plate 120 via a connector 190. Details thereof will be described below. As used herein, the first horizontal direction may be a direction perpendicular to a front of the valve housing 110, and a vertical direction may be a direction perpendicular to a lower surface of the valve housing 110 (e.g., perpendicular to the first horizontal direction).

In addition, a driving rod coupling roller 172 is installed at a lower end of the valve rod 130 and inserted into a driving rod inclined recess 171 formed on the driving rod 170. Accordingly, the lower end of the valve rod 130 may be moved up and down and horizontally, together with the upper end thereof in conjunction with the operation of the driving rod 170.

The guide housing 140 is disposed below the valve housing 110 and connected to the outside of the valve housing 110. As an example, the guide housing 140 may function to protect and embed major operating units, such as the L-motion block 150 and the driving block 160.

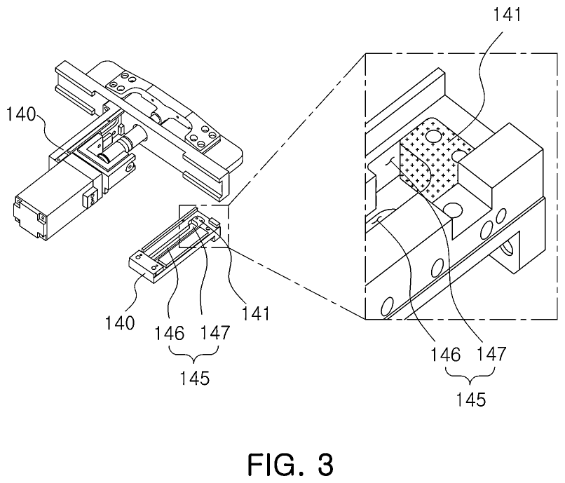

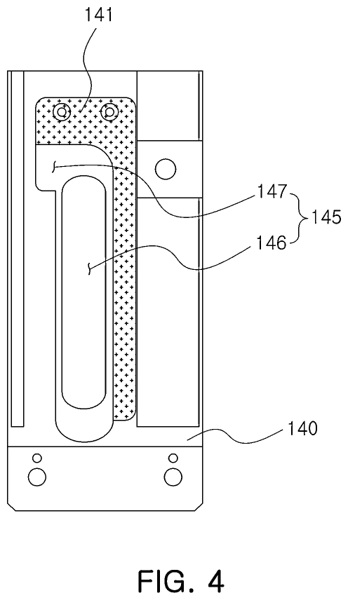

Meanwhile, as illustrated in FIGS. 3 and 4, a cam block guide 141 may be provided on both inner surfaces of the guide housing 140 to allow the cam block 160 to be moved in a first horizontal direction (opening/closing direction) after the cam block 160 operates only in a vertical direction.

As an example, the cam block guide 141 may have a shape similar to an “L” shape turned upside down, that is, a shape similar to “T.” Meanwhile, the cam block guide 141 may be formed of a special steel material and may serve to suppress wear by a guide roller 151, which will be described below. In addition, as illustrated in FIGS. 3 and 4, the guide housing 140 includes an L-motion guide groove 145. The L-motion guide groove 145 may include a vertical driving section groove 146 and an opening/closing driving section groove 147. The vertical driving section groove 146 is formed vertically, into which the guide roller 151 is inserted and guided, and the opening/closing driving section groove 147 is formed continuously in the horizontal direction toward a closing direction in which the door plate 140 closes the opening 114 above the vertical driving section groove 146. In addition, the L-motion guide groove 145, when viewed as a whole, has a shape similar to an “L” shape turned upside down, that is, a shape similar to “Γ.”

The L-motion block 150 is installed inside the guide housing 140 and is coupled to and connected to the valve rod 130. The guide roller 151 may be installed on both sides of the motion block 150. The guide roller 151 may be installed to extend to the inside of both inner surfaces of the guide housing 140 to assist the operation in which the guide roller 151 is inserted into an inclined recess 162 of the cam block 160 to be described below. The guide roller 151 may be moved along the L-motion guide groove 145. As an example, the guide roller 151 may be moved along the vertical driving section groove 146 formed vertically and the opening/closing driving section groove 147 formed continuously in the horizontal direction toward a closing direction in which the door plate 140 closes the opening 114 above the vertical driving section groove 146. Meanwhile, the guide roller 151 may be supported and guided by the cam block 160 as well as the guide housing 140.

The cam block 160 may be installed inside the guide housing 140 and may be provided with a valve rod passage hole 161 having a size through which the valve rod 130 may freely pass and be driven in the vertical and horizontal directions. The inclined recesses 162 may be provided on both sides of the cam block 160 and formed to be inclined toward the closing direction in which the door plate 120 closes the opening 112 downwardly. For example, the inclined recesses 162 may be inclined at an angle with respect to the first horizontal direction.

In the driving rod 170, the driving rod inclined recess 171 may be formed to be inclined in the closing direction downwardly, into which the driving rod coupling roller 172 is inserted and moved. For example, the driving rod inclined recess 171 may be inclined at an angle with respect to the first horizontal direction. In addition, the driving rod 170 is coupled to a lower side of the cam block 160 and the cam block 160 operates in conjunction with the operation of the driving rod 170.

An elastic member (not shown) providing elastic force may be installed between the L-motion block 150 and the driving rod 170. Accordingly, by the operation of the driving rod 170, the opening 112 may be smoothly opened by the door plate 120. In this regard, when the opening 112 is opened by the door plate 120, the L-motion block 150 moves in the opening direction (e.g., the first horizontal direction), and when the L-motion block 150 is horizontally moved, the cam block 160 operates downwardly (e.g., the vertical direction). In this case, if a downward operation of the L-motion block 150 is not prevented, the L-motion block 150 may operate in a downward inclined direction, rather than being opened in the horizontal direction, resulting in the possibility of malfunction or interference. Accordingly, the vertical movement of the L-motion block 150 may be prevented by the elastic member until the L-motion block 150 is completely opened in the horizontal direction, thereby allowing for a smooth operation. As an example, the elastic member may be a coil spring.

Meanwhile, the elastic member is installed between the L-motion block 150 and the driving rod 170, and in order for the driving rod 170 to be efficiently coupled to the lower side of the cam block 160, a lower side of the driving rod 170 is coupled to the inner side of the lower surface of the cam block 160 and an upper side of the cam block 160 is coupled to the valve rod passage hole 161. In addition, a cylindrical connector 174 is further provided to allow an elastic member to be installed on an inner circumferential surface of the driving rod 170. Meanwhile, the cylindrical connector 174 may be manufactured as a separate component and coupled to the driving rod 170. The cylindrical connector 174 may be formed integrally with the driving rod 170 or with the piston 182.

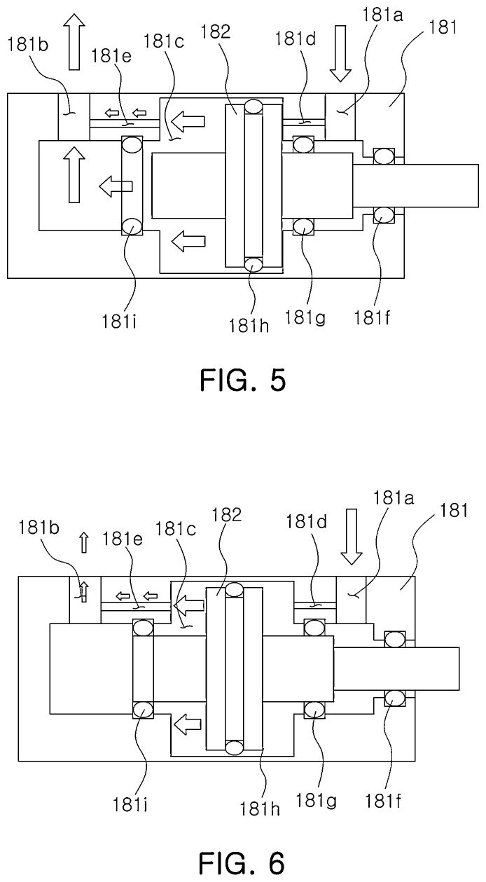

The driving unit 180 serves to drive the driving rod 170 vertically (e.g., in the vertical direction). To this end, the driving unit 180 may include a piston 182 installed inside a cylinder 181, driven up and down by pneumatic pressure, and connected upwardly to the driving rod 170. The cylinder 181 may be generally connected to the lower side of the guide housing 140. Meanwhile, as illustrated in FIGS. 5 and 6, the cylinder 181 may include an inlet 181a and an outlet 181b through which air enters and exits, respectively, so that the piston 182 may be raised and lowered by pneumatic pressure. Meanwhile, the cylinder 181 may include a piston movement recess 181c into which the piston 182 is inserted. In addition, the cylinder 181 may include a first orifice 181d connecting the inlet 181a to the piston movement recess 181c and a second orifice 181e connecting the outlet 181b to the piston movement recess 181c. The first and second orifices 181d and 181e may serve to reduce shock, noise, and vibrations occurring when the piston 182 is driven. In addition, the cylinder 181 may include a plurality of sealing members 181f to 181i. Accordingly, when the piston 182 is driven, the shock, noise, and vibrations of the piston 182 and the cylinder 181 may be reduced by the plurality of sealing members 181f to 181i.

The connector 190 serves to connect the valve rod 130 to the door plate 120. A detailed description of the connector 190 will be given below.

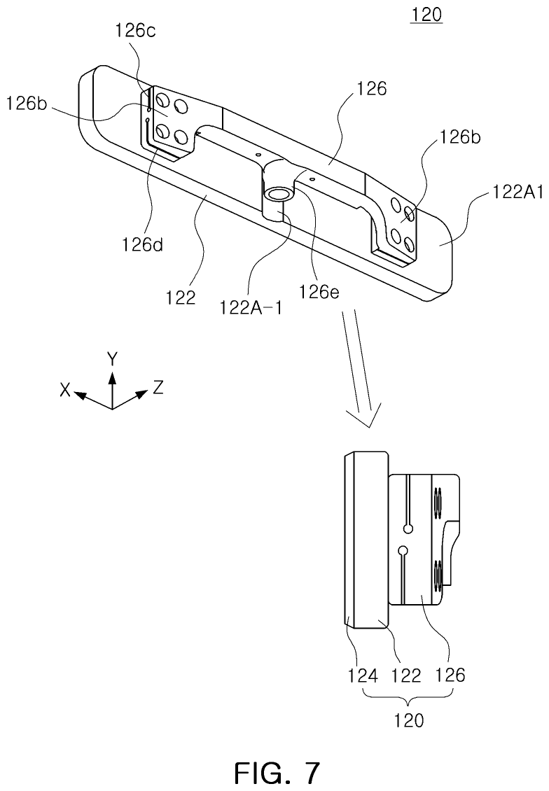

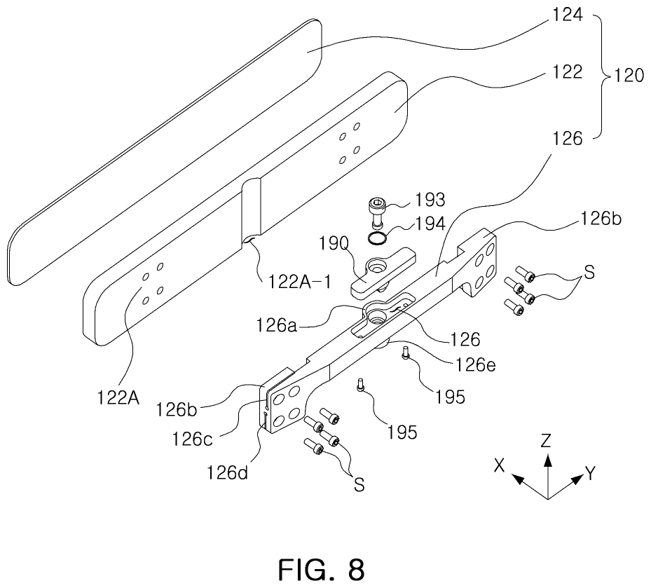

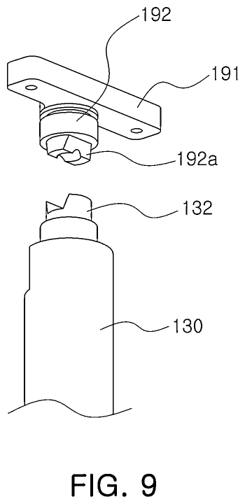

FIG. 7 is a perspective view illustrating the door plate of the slit valve apparatus according to an example embodiment, FIG. 8 is an exploded perspective view illustrating the door plate of the slit valve apparatus according to an example embodiment, and FIG. 9 is a perspective view illustrating the combination of the valve rod and the connector of the slit valve apparatus.

Referring to FIGS. 7 and 8, the door plate 120 may include a sealing plate 122, a sealing ring 124, and a connection block 126.

The sealing plate 122 has a front surface and a rear surface 122A that are opposite to each other, and may substantially have a plate shape. Meanwhile, the front surface of the sealing plate 122 is a surface facing the inner surface of the valve housing 110 in which the opening 112 is formed, and may include a flat surface. A first horizontal direction (e.g., the X-axis direction illustrated in FIGS. 7 and 8) may be defined as a direction, perpendicular to the front surface of the sealing plate 122, and a second horizontal direction (e.g., the Y-axis direction illustrated in FIGS. 7 and 8) and a vertical direction (e.g., the Z-axis direction illustrated in FIGS. 7 and 8) may be defined as directions, parallel to the front surface of the sealing plate 122 and perpendicular to each other.

The sealing plate 122 may have a rectangular shape when viewed in the first horizontal direction (e.g., the X-direction). That is, the sealing plate 122 may have a longer side extending in the second horizontal direction (e.g., the Y-direction) and a shorter side extending in the vertical direction (e.g., the Z-direction).

As an example, the sealing plate 122 may include aluminum or an aluminum alloy.

The sealing ring 124 may be attached to the front surface of the sealing plate 122. The sealing ring 124 may have a ring shape continuously extending along the perimeter of the front surface of the sealing plate 122. For example, the sealing ring 124 may be attached to the front surface of the sealing plate 122 through an adhesive member or may be fitted into a mounting recess 126a provided on the front surface of the sealing plate 122. The sealing ring 124 may include a material having excellent elasticity, for example, rubber.

The connection block 126 may be connected to the rear surface 122A of the sealing plate 122. The center of the connection block 126 may be provided with a mounting recess 126a into which the connector 190 is inserted and installed. A concave portion 122A-1 may be provided in the center of the rear surface 122A of the sealing plate 122. Meanwhile, a protrusion 126e accommodated in the concave portion 122A-1 of the sealing plate 122 may be provided in the center of the connection block 126. The concave portion 122A-1 includes a concave curved surface, and the protrusion 126e of the connection block 136 may include a convex curved surface facing the concave portion 122A-1 of the sealing plate 122.

Meanwhile, both ends of the connection block 126 may be provided with coupling portions 126b coupled to the rear surface 122A of the sealing plate 122 through screws S. The coupling portions 126b may be provided at opposite ends of the connection block 126. Each coupling portion 126b may have at least one screw hole 126b1 into which the screw S is inserted and coupled. In example embodiments, the each coupling portion 126b may have a plurality of screw holes 126b1, and a screw S may be inserted into each of the screw holes 126b1 to couple the connection block 126 to the rear surface 122A. In addition, each coupling portion 126b may include a first hinge recess 126c and a second hinge recess 126d. The first hinge recess 126c may be provided on an upper portion of each of the coupling portions 126b, and the second hinge recess 126d may be provided on a lower portion of each of the coupling portions 126b. The first and second hinge recesses 126c and 126d may serve to relieve stress concentration applied to the coupling portion 126b.

As described above, the connector 190 may be inserted into and disposed in the mounting recess 126a of the connection block 126. As an example, the connector 190 illustrated in FIG. 9 may include a body 191 inserted into the connection block 126 and having a substantially rectangular parallelepiped shape and an extension portion 192 extending from the bottom of the body 191. Meanwhile, a second wedge portion 192a corresponding to a first wedge portion 132 provided at an upper end of the valve rod 130 may be provided at a lower end of the extension portion 192. In addition, the first wedge portion 132 may have a protrusion shape, the second wedge portion 192a may have a recess into which the first wedge portion 132 is inserted, and a coupling portion in which the first wedge portion 132 is coupled to the second wedge portion 192a may have a cylindrical shape. For example, the coupling portion formed by the coupling of the first wedge portion 132 and the second wedge portion 192a may have a cylindrical shape. The connection portion 190 and the valve rod 130 may be fixed by a coupling screw 193 in a state in which the first wedge portion 132 and the second wedge portion 192a are coupled. For example, the connection portion 190 and the valve rod 130 may be coupled together by a coupling screw 193, such that the connection portion 190 and the valve rod 130 are fixed together. As an example, a washer 194 may be disposed between the coupling screw 193 and the body 191. Meanwhile, the connector 190 may be fixed to the connection block 126 by a fixing screw 195.

In this manner, as the valve rod 130 and the connector 190 are coupled by the first and second wedge portions 132 and 192a, the door plate 120 may be prevented from rotating.

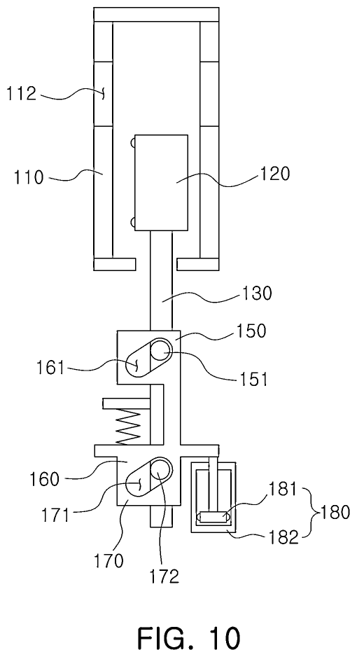

FIGS. 10 to 12 are diagrams illustrating the operation of the slit valve apparatus according to an example embodiment.

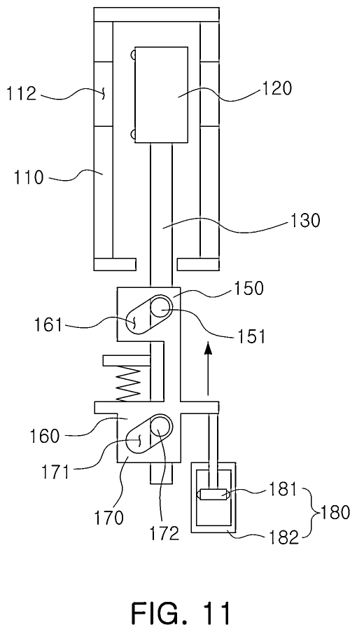

In a state in which the door plate 120 is below a level of the opening 112, leaving open the opening 112 of the valve housing 110 as illustrated in FIG. 10, the driving unit 180 operates and the valve rod 130, the L-motion block 150, the cam block 160, and the driving rod 170 rise together until the door plate 120 rise to the maximum rise position, as shown in FIG. 11. In example embodiments, the maximum rise position may be a position at which the door plate 120 is parallel to the opening 112.

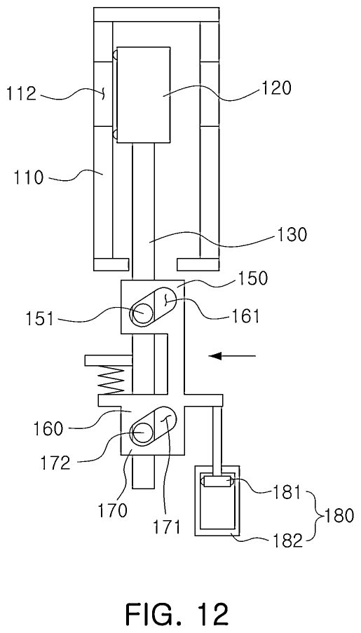

Thereafter, as illustrated in FIG. 12, when the cam block 160 and the driving rod 170 rise further together, the guide roller 151 of the L-motion block 150 is guided along the inclined recess 162 of the cam block 160, while the L-motion block 150 and the valve rod 130 move horizontally in the closing direction. At this time, as the driving rod coupling roller 172 installed below the valve rod 130 is also guided along the driving rod inclined recess 171, the lower side of the valve rod 130 is also horizontally moved in the closing direction. In example embodiments, the closing direction may be the direction from a center of the valve housing 110 toward the opening 112 (e.g., the first horizontal direction).

Accordingly, a middle portion of the valve rod 130 coupled to the L-motion block 150 and the lower side of the valve rod 130 are horizontally moved in the closing direction. Accordingly, the valve rod 130 is horizontally moved in the closing direction, while being maintained to be parallel to the vertical direction overall. Accordingly, the door plate 120 connected to the upper side of the valve rod 130 closes the opening 112 and the closing operation is completed.

Meanwhile, the operation of the door plate 120 opening the opening 112 of the valve housing 110 is performed in the reverse order of the operation of the door plate 120 closing the opening 112 of the valve housing 110.

The slit valve apparatus capable of preventing the door plate from rotating may be provided.

In addition, the slit valve apparatus capable of alleviating shock occurring during an operation and reducing noise and vibrations.

While example embodiments have been illustrated and described above, it will be apparent to those skilled in the art that modifications and variations could be made without departing from the scope of the present inventive concept as defined by the appended claims.

What is claimed is:

1. A slit valve apparatus comprising:
a door plate configured to open and close an opening of a valve housing;
a valve rod connected to the door plate;
a guide housing disposed at a lower end of the door plate and disposed so that the valve rod passes therethrough;
an L-motion block disposed in an internal space of the guide housing and connected to the valve rod;
a cam block connected to the L-motion block and disposed in the internal space of the guide housing;
a driving rod connected to a lower end of the valve rod; and
a driving unit connected to the driving rod to drive the driving rod,
wherein the slit valve apparatus further comprises a connector installed in the door plate and connected to the valve rod,
wherein the connector includes a body disposed in the door plate and an extension portion extending from a lower end of the body, and
wherein the extension portion includes a first wedge portion configured to prevent the door plate from rotating, and the valve rod includes a second wedge portion corresponding to the first wedge portion.

2. The slit valve apparatus of claim 1,
wherein the first wedge portion has a protrusion shape, and the second wedge portion has a recess into which the first wedge portion is inserted, and
wherein a coupling portion formed by the coupling of the first wedge portion and the second wedge portion has a cylindrical shape.

3. The slit valve apparatus of claim 2, wherein the connector and the valve rod are coupled together by a coupling screw.

4. The slit valve apparatus of claim 1, wherein the door plate includes a sealing plate having a plate shape, a sealing ring coupled to a first surface of the sealing plate, and a connection block coupled to a second surface of the sealing plate.

5. The slit valve apparatus of claim 4, wherein a center of the connection block is provided with a mounting recess into which the connector is inserted and installed.

6. The slit valve apparatus of claim 4, wherein the connection block includes a coupling portion disposed at each end, and the coupling portion includes a first hinge recess and a second hinge recess spaced apart from the first hinge recess.

7. The slit valve apparatus of claim 5, wherein the connector is fixedly installed by the connection block and a fixing screw.

8. The slit valve apparatus of claim 1, wherein the driving unit includes a cylinder having an internal space and a piston driven up and down in the internal space of the cylinder.

9. The slit valve apparatus of claim 8, wherein the cylinder includes an inlet through which air flows, an outlet spaced apart from the inlet, and a piston movement recess disposed between the inlet and the outlet and configured to allow the piston to move therein.

10. The slit valve apparatus of claim 9, wherein the cylinder includes a first orifice connecting the inlet to the piston movement recess and a second orifice connecting the outlet to the piston movement recess.

11. The slit valve apparatus of claim 10, wherein the cylinder includes a plurality of sealing members configured to alleviate shock and reduce noise and vibration when the piston moves.

12. The slit valve apparatus of claim 1, wherein the guide housing includes a cam block guide on each of two side of an internal surface to guide movement of the L-motion block.

13. The slit valve apparatus of claim 12, wherein an L-motion guide groove corresponding to a shape of the cam block guide is provided on the each of the two sides of the internal surface of the guide housing.

14. The slit valve apparatus of claim 13, wherein the L-motion guide groove includes a vertical driving section groove formed in a vertical direction and an opening and closing driving section groove formed in a horizontal direction above the vertical driving section groove.

15. The slit valve apparatus of claim 14, wherein the L-motion block includes a guide roller inserted into the L-motion guide groove and configured to move along the L-motion guide groove.

16. The slit valve apparatus of claim 1, wherein the cam block includes a valve rod passage hole having a size allowing the valve rod to be driven in vertical and horizontal directions.

17. The slit valve apparatus of claim 16, wherein both sides of the cam block are provided with an inclined recess formed to be inclined toward a closing direction in which the door plate closes the opening.

18. The slit valve apparatus of claim 1, wherein the driving rod includes a driving rod inclined recess formed to be inclined in a closing direction, while a driving rod coupling roller is inserted and moved downwardly.

19. A slit valve apparatus comprising:
a door plate configured to open and close an opening of a valve housing;
a valve rod connected to the door plate;
a guide housing disposed at a lower end of the door plate and disposed so that the valve rod passes therethrough;
an L-motion block disposed in an internal space of the guide housing and connected to the valve rod;
a cam block connected to the L-motion block and disposed in the internal space of the guide housing;
a driving rod connected to a lower end of the valve rod; and
a driving unit connected to the driving rod to drive the driving rod,
wherein the driving unit includes a cylinder having an internal space and a piston driven up and down in the internal space of the cylinder,
wherein the cylinder includes an inlet through which air flows, an outlet spaced apart from the inlet, and a piston movement recess disposed between the inlet and the outlet and configured to allow the piston to move therein, and
wherein the cylinder includes a first orifice connecting the inlet to the piston movement recess and a second orifice connecting the outlet to the piston movement recess.

20. The slit valve apparatus of claim 19, wherein the cylinder includes a plurality of sealing members to alleviate shock and reduce noise and vibration when the piston moves.
